(19) United States
(12) Patent Application Publication
(10) Pub. No.: US 2011/0209557 A1
(43) Pub. Date: Sep. 1, 2011

(54) FIBROUS ASSEMBLY

(75) Inventors: Michael Kenneth Burns, Devon (GB); Julian Roger Wright, Devon (GB); Kenneth Ernest Evans, Devon (GB)

(73) Assignee: UNIVERSITY OF EXETER, Exeter (GB)

(21) Appl. No.: 13/121,974

(22) PCT Filed: Oct. 7, 2009
(86) PCT No.: PCT/GB2009/002389

§ 371 Date: May 13, 2011

(30) Foreign Application Priority Data
Oct. 9, 2008 (GB) 0818523.3

(51) Int. Cl. G01N 3/08; B23P 11/00

(52) U.S. Cl. 73/828; 29/428

(57) ABSTRACT

A fibrous assembly includes two components. The first component provides a visual indication of when a pre-determined tensile load is applied to the assembly or when the fibres of the assembly have been over-extended. The first and second components are movable relative to each other, the visual indication being provided by the first component being substantially concealed by the second component and becoming at least partially exposed when the pre-determined tensile load is applied to the assembly or when the fibres have been over-extended. The first component comprises auxetic yarn.

The present invention relates to a fibrous assembly which is able to provide a visual indication of when a tensile load of at least a pre-determined level is applied to the assembly or when the fibres of the assembly have been over-extended. This is particularly of use in, for example, the construction industry and other industries where lifting of heavy loads is required.

Fibrous assemblies such as sling webbings and the like are in everyday use in the construction industry and other environments where a mechanism for the lifting of heavy loads is required. When such heavy loads are being lifted, it is important to know that the equipment being used is in good condition and is reliable to carry out the lifting. Over time, the fibres used in lifting equipment such as sling webbings become strained and extended with use and a point will be reached when they are no longer capable of safely supporting and lifting the heavy loads. This creates a potentially dangerous situation for people working with these heavy loads if the fibres in the fibrous assembly are not able to adequately support them. This is unacceptable from a health and safety perspective. However, there is currently no means of obtaining a visual indication from the fibres of when they have been over-extended and are therefore no longer fit for purpose.

There is also currently no means of obtaining a visual indication from a fabric of when an optimum or maximum safe load has been applied to the fibres in the lifting equipment. The maximum safe load is the load that the fabric can withstand without being over-extended. Such an indication would enable the life of any given fibrous assembly to be extended as it would be less likely to be exposed to loads which are in fact too heavy for it for any length of time and which cause over-extending.

U.S. Pat. No. 6,006,860 details a safety harness which is made of a first stretchable material having a second, differently coloured material woven into or attached to it such that the second material is permanently visible on the exterior surface of the harness. The first material is more elastic than the second material. When the harness is subjected to a sudden force, the first material stretches and returns to its normal position while the second, less elastic material ruptures. The rupture is used as a sign that the harness is damaged.

The harness of U.S. Pat. No. 6,006,860 only indicates when a certain load has been applied, i.e. a load sufficient to break the second material. It does not indicate when an optimum or maximum safe operating load for any given fibrous assembly has been arrived at. Additionally, the rupture in the second material may be difficult to spot.

It is therefore an object of the present invention to provide a fibrous assembly which gives a clear visual indication of when the fibres of the fibrous assembly have become over-extended or when they have been exposed to a specific pre-determined tensile load.

According to the present invention there is provided a fibrous assembly comprising at least a first component and a second component wherein the first component provides a visual indication of when at least a pre-determined tensile load is applied to the assembly or when the fibres of the assembly have been over-extended, the first and second components being movable relative to each other, the visual indication being provided by the first component being substantially concealed by the second component and becoming at least partially exposed when the at least pre-determined tensile load is applied to the assembly, or when the fibres have been over-extended, wherein the first component comprises auxetic yarn.

To provide the visual indication, the first component ‘pops out’ from its substantially concealed position under the second component and becomes visible when a tensile load above a certain pre-determined weight is applied to the assembly. To aid the visual indication, the first component is typically a different colour to the second component, and is advantageously a colour which provides a clear visual contrast from the second component (which is typically a lighter colour such as white), such as a bright or darker colour. Once the tensile load is removed, if the fibres have not been over-extended, the first component will be substantially re-concealed underneath the second component once more. If the fibres have been deployed beyond their safe working limit and been over-extended, the first component will remain at least partially exposed. The visible presence of the coloured first component against the different coloured fibres will indicate to a subsequent user that the assembly is not working at its optimum level and may not be able to safely lift heavy loads in the future. The visual indication also serves to show to a user what the optimum or maximum weight is that any particular fibrous assembly is capable of safely lifting without being over-extended or potentially damaged.

According to one aspect of the invention, the first component is either substantially re-concealed if the assembly has not been over-extended, or it remains at least partially exposed if the fibres have been over-extended.

According to a further aspect of the invention, once the tensile load is removed, the first component may be able to return to its substantially concealed position even when the maximum load capacity of the fibrous assembly has been exceeded and if the fibres are over-extended, when the first component is of a diameter smaller than a pre-determined size. This smaller diameter enables the first component to force a return path through the fibres even when the fibres have been over-extended.

It is possible to manufacture the assembly of the invention so that it is known what the maximum loading capacity of any individual fibrous assembly is, and so that the visual indication first manifests itself at that load level.

By “substantially concealed” it is meant that the first component is either completely concealed by the second component or only a negligible number of individual fibres are visible under it.

By “over-extended” it is meant that the fibres of the assembly are stretched under the tensile load such that they are unable to return to their original length and orientation once the load is removed.

Typically, more than one first component is used in the assembly. More typically, there is more than one piece of the first component and more than one piece of the second component in any one heald. Advantageously, there are two pieces of the first component and two pieces of the second component in any one heald.

The first component comprises an auxetic yarn, and typically more than one piece thereof. Auxetic yarns have a property that when stretched, contrary to most materials, they become thicker rather than thinner perpendicular to the applied force, i.e., they have a negative Poisson's ratio.

Auxetic yarn is known in the art. US 2007/210011 describes the use of auxetic yarn in filtration and in the removal of matter lodged in pores of a filtration apparatus.

WO 2007/125352 describes a fibrous assembly comprising at least two composite fibres for detecting and measuring forces a structure is subjected to. In WO 2007/125352, an optical fibre is used as part of the composite fibre to detect the forces, as the light transmission through it varies with different degrees of strain. This variation in the level of light transmission can be measured and the degree of strain calculated therefrom. The present invention does not require an optical fibre to enable the detection of a specific load.

WO 2004/088015 describes composite components comprising auxetic materials for use in impact protection equipment and in load spreading. It does not use them as a warning mechanism to give a visual indication of when a fibrous assembly is unsafe for use with heavy loads.

Even more advantageously, the first component is applied as a warp end or weft.

The auxetic yarn typically comprises an elastomer. As the elastomer, any polymer exhibiting elastomeric properties could be used, including, but not limited to polyurethane, polyester, and nylon, as its core element. The diameter of the elastomer may typically be from about 0.5 mm to about 3.0 mm, more typically from about 0.6 to about 2.0 mm.

Another polymeric component, such as a high modulus polymeric component is typically combined with the elastomer.

According to one aspect of the invention, the auxetic yarn is a polyurethane core surrounded by a high modulus polymeric component, such as an Ultra High Molecular Weight polyethylene, for example a polyethylene wrap comprising Dyneema® (a product of the DSM company) which is a superstrong polyethylene fibre that provides a great deal of strength combined with minimum weight, or Spectra® (a product of Honeywell fibres), or Kevlar®. The high modulus polymeric component is typically wrapped or wound around the elastomer, more typically in a helical manner.

The high modulus polymeric component typically has a decitex value (a unit of the linear density of a continuous filament or yarn) of between about 200 to about 750, more typically between about 300 to about 500, still more typically about 400.

The wrap angle of the auxetic yarn (i.e. the angle at which the high modulus polymeric component is wrapped around the elastomer) can be varied as desired. The choice of wrap angle, in combination with the choice of the particular auxetic yarn and its diameter will affect the performance and mode of visual indication of the fibrous assembly of the invention as it impacts upon the control of the response of the fibrous assembly to strain caused by a load. It is therefore possible to vary the maximum safe load of any given fibrous assembly in this way. Thus, even when the auxetic yarn is narrow enough to find a return path through the fibres even when the fibres have been over-extended, a suitable variation of the wrap angle can prevent the yarn from returning through the fibres and ensuring that they remain exposed when the fibres have been over-extended. The wrap angle may be any angle between about 15 and about 75 degrees, more typically between about 25 and about 50 degrees.

As the high modulus polymeric component, any polymeric fibre having a high modulus can be used, such as but not limited to polyethylene or aramids (aromatic polyamides). By high modulus is meant an ultimate tensile strength of a minimum of approximately 40 g/dtex or a modulus of approximately 1300 g/dtex.

The second component typically comprises a fabric, such as but not limited to polyester, polypropylene, polyamide or other thermoplastic polymer fibres. Other similar materials which can be used as the fabric will be readily apparent to a skilled person.

According to a further aspect of the invention, there is provided a method of manufacturing a fibrous assembly as described hereinabove, comprising the steps of:
i) providing at least a first component and a second component, wherein the first component comprises auxetic yarn; and
ii) combining the first component with the second component so that the first component is substantially concealed by the second component, and so that the first and second components are movable relative to each other.

According to a further aspect of the invention, there is provided a rope, belt, harness, bandage, restraint, sail, strappings or geotextile comprising a fibrous assembly as described hereinabove.

According to a further aspect of the invention, there is provided a lifting device for a tensile load comprising a fibrous assembly as described hereinabove.

According to a further aspect of the invention, there is provided a method of evaluating whether a specific pre-determined load has been applied to a fabric, or when the fabric has been over-extended, comprising using a fibrous assembly as described hereinabove.

According to a further aspect of the invention, there is provided the use of a fibrous assembly as described hereinabove in providing a visual indication of when a fabric has been over-extended or when a specific pre-determined load has been applied to the fabric.

The fabric may be any one or more selected from a rope, belt, harness, bandage, restraint, sail, strapping or geotextile.

The present invention may be used in, for example, safety, climbing, or parachute harnesses, pressure bandages, cargo restraints, power transmission belts, sails, freight vehicle strappings and geotextiles, e.g. motorway reinforcement strappings. This list is non-exhaustive, and further potential applications will be apparent to persons skilled in the art. Auxetic yarns have never before been applied to such purposes in this manner.

The invention will now be described further by way of example with reference to the following figures which are intended to be illustrative only and in no way limiting upon the scope of the invention.

FIG. 1 illustrates the concept and principles of a standard helical auxetic yarn and fabric known in the art.

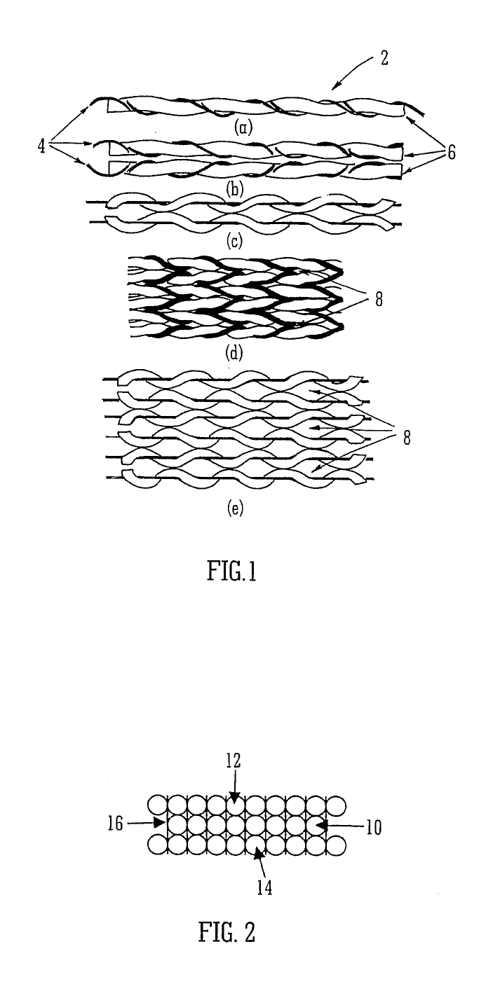

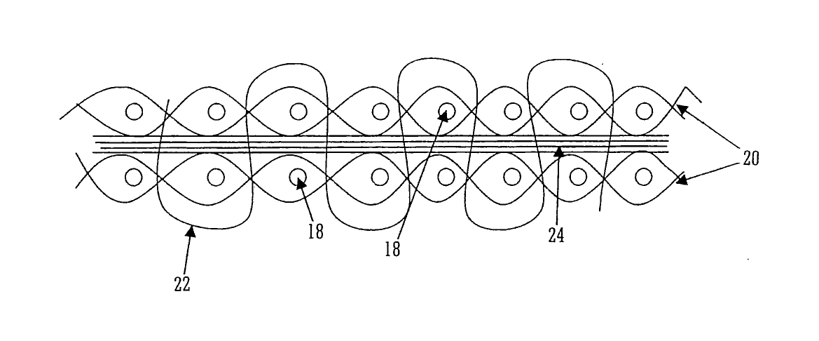

FIG. 2 shows a cross-section of the fibrous assembly.

FIG. 3 shows a side-elevation of the fibrous assembly.

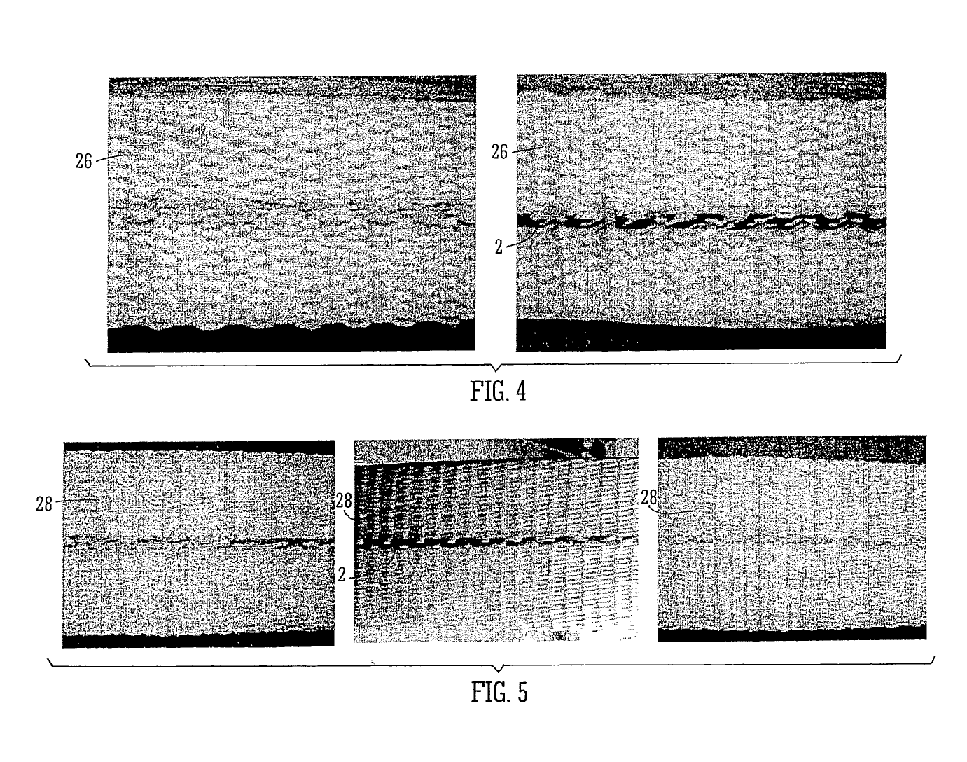

FIG. 4 shows a fibrous assembly with auxetic yarns as face warp ends.

FIG. 5 shows a fibrous assembly with auxetic yarns as face warp ends.

FIG. 1 illustrates the concept and principles of a standard helical auxetic yarn and fabric as is known in the art. A thin, high-modulus polymeric wrap 4 is helically wound around a much thicker, elastomeric core 6 to make an auxetic yarn 2 (FIG. 1(a)). Two such cores and wraps are advantageously used together to form a base pair as shown in FIG. 1(b). When a sufficiently large tensile load is applied to the fabric containing the auxetic yarn 2, the wrap 4 straightens, forcing the core 6 to displace such that the composite structure becomes wider and exhibits a negative Poisson's Ratio (FIG. 1(c)).

An array of the base-paired yarns 2 forms a flat-sheet fabric (FIG. 1(d)). At low strain levels, the pores 8 of the yarn 2 between the adjacent cores 6 are more or less closed. As strain is applied to the fabric containing the yarn 2, the pores 8 open up. By controlling the degree of strain it is possible to control the sizes of the pores 8 (FIG. 1(e)).

FIG. 2 shows the relationship of the warp 12 and 14, filler 10 and binder 16 yarns to each other in a fabric. Because the auxetic yarns were laid in the warp direction the representation of the weft has been omitted for clarity. It can be seen that the filler ends 10 lie between the face and back warp ends 12 and 14 and therefore are less visible. By placing one auxetic yarn at the face warp 12 and one in the filler the filler end 10 augments the warp end as the warp end is displaced laterally at the application of a longitudinal tensile load.

FIG. 3 illustrates a side view of a fabric, showing the possible directions (weft and warp yarns 18 and 20, respectively) and functions (binder and filler yarns 22 and 24, respectively) the yarns can be used for.

FIG. 4 shows the fabric 26 comprising auxetic yarns as warp face ends according to a preferred embodiment of the invention. The upper picture shows the fabric prior to any tensile loading with a negligible amount of the red-coloured auxetic yarn visible through the fabric, while the lower picture shows the fabric after tensile loading and after the fabric has been allowed to relax. It can be seen in the lower picture that the darker coloured auxetic yarn 2 is still visible after the loading.

FIG. 5 shows a fabric 28 with auxetic yarns as face warp ends. The top picture is the fabric prior to any tensile loading, while the middle picture shows it while under a tensile load of 20 kN. In this middle picture, the darker coloured auxetic yarn 2 is clearly visible against the lighter coloured fabric, showing that the fabric has reached or exceeded its pre-determined tensile load threshold. The lower picture shows the fabric after tensile loading but after the fabric has been allowed to relax. In this picture, the auxetic yarn 2 is no longer visible as the fabric was not over-extended during the period of tensile loading and has returned to its concealed position under the fabric.

Exemplary embodiments of the invention will now be explained with reference to the description herein below.

An auxetic yarn comprising a 0.6 mm diameter polyurethane core and a 400 decitex Dyneema® wrap was used. A narrow fabric, a cargo harness and webbing, constructed as a 2-ply simplex fabric of plain weave geometry was chosen as a starting fabric. The fabric consists of 128 warp and filler ends of 2200 decitex flat polyester and 16 binder ends of 1100 decitex flat polyester, it has a width of 25 mm and thickness of 1.7 mm, and an ultimate breaking strength of 20 kN.

The auxetic yarns could be identified by the bright red colour used for the polyurethane core.

In order to minimise the yarns rotating around each other during the weaving process, and also to more completely conceal the auxetic yarns, a fabric comprising two ends of auxetic yarn and two ends of polyester in the same heald was created. When the yarn was applied as a warp end, the yarn became visible even at the lower end of the tensile spectrum (as shown in FIG. 4).

The auxetic yarn was also used on a second fabric type, a standard simplex 1 tonne capacity load bearing webbing. This webbing is constructed using more polyester ends, therefore giving more capacity to conceal the auxetic yarns.

The tensile loading had the desired effect and the auxetic yarns were exposed as predicted after the load had exceeded the safe working load, which in this case is 1 tonne. Loading was continued to exceed 5 tonnes though there was minimal noticeable change in the amount of auxetic yarn displaced with increasing load.

Cyclic loading was investigated to simulate and observe the effects of multiple episodes of loading and relaxation of the webbing. The webbing was loaded to 2 tonnes, then taken to 5 tonnes for 20 cycles. Again the auxetic yarn reacted, though it remained buried under the polyester warp upon relaxation.

In this example, upon release of the tensile load and subsequent relaxation of the webbing the auxetic yarns reburied themselves within the body of the fabric, because the auxetic yarn was narrow enough to force a return path through the polyester fibres. A coarser or smaller diameter auxetic fibre in combination with a suitable choice of wrap angle (to control the strain response) would remain exposed upon relaxation of the narrow fabric.

This ‘reversible’ phenomenon is itself also important, as it has applications in, for example, indicating when a material has reached the required strain, even if it is beyond the maximum load capacity of the material, such as in the tightening of bandages, cargo straps and other manual applications indicating that the applied force is sufficient and has reached a given end point. This gives precision handling and exact repeatable results on application of devices, thus minimising operator interpretation and error.

The present invention therefore shows that when an auxetic yarn is inserted in a narrow fabric it can be made to ‘pop out’ from its concealed position under the fabric and provide a visual indication of applied load or tension. By appropriate design the auxetic yarn could be made to remain exposed or to return beneath the outer faces of the fabric. Suitable design optimisation could lead to applications as overextension or end-of-life indicators or reversible changes to indicate ‘optimal’ application of tension, for example in pressure bandages, cargo restraints, power transmission belts, sails and freight vehicle strappings.

It is of course to be understood that the present invention is not intended to be restricted to the foregoing examples which are described by way of example only.

1. A fibrous assembly comprising at least a first component and a second component wherein the first component provides a visual indication of when at least a pre-determined tensile load is applied to the assembly or when the fibres of the assembly have been over-extended, the first and second components being movable relative to each other, the visual indication being provided by the first component being substantially concealed by the second component and becoming at least partially exposed when the at least predetermined tensile load is applied to the assembly or when the fibres have been over-extended, wherein the first component comprises auxetic yarn.

2. A fibrous assembly according to claim 1, wherein the first component is either substantially re-concealed if the assembly has not been over-extended, or it remains at least partially exposed if the fibres have been over-extended.

3. A fibrous assembly according to claim 1, wherein, once the tensile load is removed, the first component can return to its substantially concealed position even if the fibres are over-extended.

4. A fibrous assembly according to claim 1, wherein the fibrous assembly comprises more than one piece of the first component.

5. A fibrous assembly according to claim 1, comprising more than one piece of the first component and more than one piece of the second component in a single heald.

6. A fibrous assembly according to claim 5, wherein there are two pieces of the first component and two pieces of the second component in a single heald.

7. A fibrous assembly according to claim 1, wherein the first component is applied as a warp end or weft.

8. A fibrous assembly according to claim 1, wherein the first component comprises an elastomer.

9. A fibrous assembly according to claim 8, wherein the elastomer comprises polyurethane, polyester or nylon.

10. A fibrous assembly according to claim 8, wherein the first component further comprises a further polymeric component.

11. A fibrous assembly according to claim 10, wherein the further polymeric component is a high modulus polymeric component.

12. A fibrous assembly according to claim 11, wherein the further polymeric component comprises polyethylene or an aromatic polyamide.

13. A fibrous assembly according to claim 9, wherein the further polymeric component is helically wrapped around the elastomer.

14. A fibrous assembly according to claim 1, wherein the second component comprises a fabric.

15. A fibrous assembly according to claim 14, wherein the second component comprises polyester, polypropylene or polyamide.

16. A fibrous assembly according to claim 1, wherein the first component is a different colour to the second component.

17. A rope, belt, harness, bandage, restraint, sail, strappings or geotextile comprising a fibrous assembly, said fibrous assembly comprising at least a first component and a second component wherein the first component provides a visual indication of when at least a pre-determined tensile load is applied to the assembly or when the fibres of the assembly have been over-extended, the first and second components being movable relative to each other, the visual indication being provided by the first component being substantially concealed by the second component and becoming at least partially exposed when the at least predetermined tensile load is applied to the assembly or when the fibres have been over-extended, wherein the first component comprises auxetic yarn.

18. A lifting device for a tensile load comprising a fibrous assembly, said fibrous assembly comprising at least a first component and a second component wherein the first component provides a visual indication of when at least a pre-determined tensile load is applied to the assembly or when the fibres of the assembly have been over-extended, the first and second components being movable relative to each other, the visual indication being provided by the first component being substantially concealed by the second component and becoming at least partially exposed when the at least predetermined tensile load is applied to the assembly or when the fibres have been over-extended, wherein the first component comprises auxetic yarn.

19. A method of manufacturing a fibrous assembly, comprising the steps of:
i) providing at least a first component and a second component, wherein the first component provides a visual indication of when at least a pre-determined tensile load is applied to the assembly or when the fibres of the assembly have been over-extended, and wherein the first component comprises auxetic yarn; and
ii) combining the first component with the second component so that the first component is substantially concealed by the second component, and so that the first and second components are movable relative to each other, the visual indication being provided by the first component being substantially concealed by the second component and becoming at least partially exposed when the at least predetermined tensile load is applied to the assembly or when the fibres have been over-extended.

20-23. (canceled)
